(19) United States
(12) Patent Application Publication
(10) Pub. No.: US 2026/0111604 A1
(43) Pub. Date: Apr. 23, 2026

(54) METHODS AND SYSTEMS FOR SECURING CONFIDENTIAL CONTENT OF A DOCUMENT USING AN AUGMENTED REALITY APPLICATION

(71) Applicant: XEROX CORPORATION, NORWALK, CT (US)

(72) Inventors: Ravindranath Mannuru, Guntur (IN); Packiya Lakshmi Balusamy, Chennai (IN); Prathi Koteswara Rao, Cuddapah (IN)

(73) Assignee: XEROX CORPORATION, NORWALK, CT (US)

(21) Appl. No.: 18/924,820

(22) Filed: Oct. 23, 2024

(51) Int. Cl. G06F 21/62

(52) U.S. Cl. CPC G06F 21/6254

(57) ABSTRACT

The present disclosure discloses methods and systems for securing confidential content of a document while printing, accessing, sharing and/or while reproducing the document. To this end, the method allows a user to select confidential content, generates a pre-defined code such as bar code corresponding to the confidential content, adds one or more symbols including bar code, logo in place of the confidential content and submits the document for printing. The document is printed such that the printed document includes non-confidential content, an IR security mark, bar code, and logo. Later at the time of accessing the secured printed document, the confidential content is retrieved and merged with the non-confidential content to output a complete document for further action such as view, print. The methods and systems disclose the implementation using an augmented reality application for securing the confidential content and/or for providing access to the confidential content.

### TECHNICAL FIELD

The present disclosure relates to the field of document security. More specifically, the disclosure relates to methods and systems for securing and providing access to confidential content of a document using an augmented reality (AR) application.

### BACKGROUND

Documents can be secured through marks such as infrared (IR) security marks. The IR security mark is a visual element where information is embedded/hidden in it for naked eye and the IR mark is printed when the document is printed. Confidential content can be exposed in the print path, resulting in data leakage. Further, when the document having the IR mark is reproduced, the document is considered confidential, and it is restricted for copy/scan operations, even if a portion of the document is not confidential. What are needed are methods and systems for securing confidential content such that the print path is devoid of confidential content, and scan/copy operations are not restricted or stopped when the document is reproduced.

### SUMMARY

According to aspects illustrated herein, a method for securing confidential content of a document while printing the document is disclosed. The method includes receiving the document for printing including the confidential content and non-confidential content, receiving selection or indication of the confidential content, separating the confidential content from the non-confidential content of the document, storing the confidential content, and masked the confidential content. The method includes adding a pre-defined code corresponding to the confidential content of the document for accessing the confidential content using a pre-defined application such as, but not limited to, an AR application, adding a pre-defined application logo around the location of the confidential content for accessing the confidential content using the pre-defined application, and submitting the document for printing such that the printed document includes the non-confidential content and the pre-defined code and the pre-defined application logo corresponding to the confidential content of the document.

According to further aspects, a method for providing access to a secured printed document at a device such as a mobile device is disclosed. The device includes an image capturing module, wherein the secured printed document includes non-confidential content, an IR security mark, a pre-defined code, and a pre-defined application logo. The method includes receiving the printed document including the non-confidential content, the IR security mark, the pre-defined code, and the pre-defined application logo. The pre-defined code is captured, upon detecting the pre-defined application logo in the printed document. The confidential content is identified and retrieved corresponding to the captured pre-defined code, and the confidential content is displayed, thereby providing access to the confidential content for further action such as view, print, and/or share. The method includes merging the retrieved confidential content with the non-confidential content of the document such that the confidential content is placed at its original position/location, and outputting a merged document including the confidential and the non-confidential content. The method includes authorizing a user, based on credentials of the user, to access the merged document. The credentials are, for example, but not limited to, login credentials, and credentials stored in the IR security mark.

According to further aspects illustrated herein, an AR application executing on a device for securing confidential content of a document is disclosed. The AR application is configured to receive the document, including the confidential content and non-confidential content, receives a selection or indication of the confidential content, and masks the confidential content. The AR application includes adding a pre-defined code corresponding to the confidential content of the document that can be used to access the confidential content, for example, but not limited to, using the AR application. The AR application includes adding an AR application logo that can be used to identify the AR application that can be used to access the confidential content. The AR application includes printing the document such that the printed document includes the non-confidential content, the pre-defined code, and the AR application logo corresponding to the confidential content of the document.

According to further aspects, an AR application executing on a device, for providing access to a secured printed document, is disclosed. The printed document includes non-confidential content, an IR security mark, a pre-defined code, and AR application logo. The AR application is configured for receiving the printed document including the non-confidential content, the IR security mark, the pre-defined code, and the AR application logo, capturing the pre-defined code, upon detecting the AR application logo in the printed document, identifying and retrieving the confidential content corresponding to the captured pre-defined code, and providing access to the confidential content.

According to further aspects, a mobile device for securing confidential content of a document is disclosed. The mobile device includes an AR application configured for receiving the document including the confidential content and non-confidential content, receiving a selection or indication of the confidential content, masking the confidential content, adding a pre-defined code corresponding to the confidential content of the document for accessing the confidential content, for example, but not limited to, using the AR application, and adding an AR application logo to identify an AR application that is used for securing the confidential content.

According to further aspects, a mobile device for providing access to a secured printed document is disclosed. The printed document includes non-confidential content, an IR security mark, a pre-defined code, and an AR application logo. The mobile device includes an AR application configured for receiving the printed document including the non-confidential content, the IR security mark, the pre-defined code and the AR application logo, capturing the pre-defined code, upon detecting the AR application logo in the printed document, identifying and retrieving confidential content corresponding to the captured pre-defined code, and providing access to the confidential content for further action.

According to additional aspects, a multi-function device for securing confidential content of a document while printing the document is disclosed. The multi-function device includes an AR application executing on the multi-function device configured for receiving the document including the confidential content and non-confidential content for printing, allowing a user to select or indicate the confidential content, masking the confidential content using one or more ways, adding a pre-defined code corresponding to location of the confidential content of the document for accessing the confidential content, adding the AR application logo for identifying the AR application that is used for securing the confidential content, and submitting the document for printing. The multi-function device further includes a print engine for printing the document such that the printed document includes the non-confidential content, the predefined code and the AR application logo corresponding to the confidential content of the document.

According to further aspects, a multi-function device for providing access to confidential content corresponding to a secured printed document is disclosed. The secured printed document includes non-confidential content, an IR security mark, a pre-defined code, and an AR application logo. The multi-function device includes a platen for receiving the secured printed document including the non-confidential content, the IR security mark, the pre-defined code, and the AR application logo. The multi-function device includes a controller for retrieving the IR security mark from the secured printed document, and for matching the AR application logo with a logo of an AR application running on the multi-function device. The multi-function device includes the AR application for capturing the pre-defined code to identify and retrieve the corresponding confidential content, and for merging the retrieved confidential content with the non-confidential content of the document to output a complete document including the confidential and the non-confidential content.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for securing and accessing confidential content of an original document. The method includes receiving the original document, receiving an indication of the confidential content in the original document, amending the original document by masking the confidential content in the original document and adding a code to the original document at a location of the masked confidential content, and outputting the amended document. Other embodiments of this aspect include corresponding computer systems, apparatus, and computer programs recorded on one or more computer storage devices, each configured to perform the actions of the methods.

Implementations may include one or more of the following features. The method may include adding a logo around the location, receiving the outputted document, detecting the logo in the outputted document, accessing the code, and identifying and retrieving the confidential content corresponding to the code. The method may include matching the logo before retrieving the confidential content, recreating the original document by merging the retrieved confidential content into the outputted document, storing the confidential content over a cloud location, generating the code, adding an infrared (IR) security mark to the amended document. Outputting the amended document may include one or more of printing the amended document or displaying the amended document. The method may include receiving the original document and the outputted document by an image capturing module. Implementations of the described techniques may include hardware, a method or process, or computer software on a computer-accessible medium.

One general aspect includes a computer system for executing an augmented reality (AR) application where the AR application secures and accesses confidential content of an original document. The computer system includes a hardware processor and a non-volatile storage medium storing instructions that when executed by the hardware processor performs operations that may include receiving the original document, receiving an indication of the confidential content in the original document, amending the original document by masking the confidential content in the original document and adding a code to the original document at a location of the masked confidential content, and outputting the amended document. Other embodiments of this aspect include corresponding computer systems, apparatus, and computer programs recorded on one or more computer storage devices, each configured to perform the actions of the methods.

Implementations may include one or more of the following features. The operations may include adding a logo around the location, receiving the outputted document, detecting the logo in the outputted document, accessing the code, and identifying and retrieving the confidential content corresponding to the code. The operations may include matching the logo before retrieving the confidential content, recreating the original document by merging the retrieved confidential content into the outputted document, and adding an IR security mark to the amended document. Outputting the amended document may include one or more of printing the amended document or displaying the amended document. The hardware processor may include one or more of a mobile device or a multi-function device. Implementations of the described techniques may include hardware, a method or process, or computer software on a computer-accessible medium.

One general aspect includes a computer program product for executing an AR application, wherein the AR application secures and accesses confidential content of an original document. The computer program product includes a computer-readable storage medium having program instructions embodied therewith, the program instructions executable by a computing device to cause the computing device to perform operations including receiving the original document, receiving an indication of the confidential content in the original document, amending the original document by masking the confidential content in the original document, adding a code to the original document at a location of the masked confidential content, adding a logo around the location, and outputting the amended document. Other embodiments of this aspect include corresponding computer systems, apparatus, and computer programs recorded on one or more computer storage devices, each configured to perform the actions of the methods.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended by way of example, and illustrates embodiments of devices, systems, and processes that are consistent with the subject matter as claimed herein.

FIG. 1A and FIG. 1B show environments in which various embodiments of the present disclosure can be practiced;

FIGS. 1C-1I show snapshots of a user interface of an AR application;

FIG. 2A is a block diagram illustrating various components of a device such as a mobile device, in accordance with embodiments of the present disclosure;

FIG. 2B is a block diagram illustrating various components of a device such as a multi-function device, in accordance with embodiments of the present disclosure;

FIGS. 3A-3E show snapshots of data for implementing the present disclosure;

FIG. 4 is a flowchart for securing confidential content of a document while printing the document; and

FIG. 5 is a method flowchart for providing access to a secured printed document including confidential content of the document.

### DESCRIPTION

Aspects of the present disclosure are explained in detail below with reference to the various figures. Configurations are described to illustrate the disclosed subject matter, not to limit its scope, which is defined by the claims. Those of ordinary skill in the art will recognize a number of equivalent variations of the various features provided in the description that follows.

In various embodiments of the present disclosure, definitions of one or more terms that are used in the document are provided below. For a person skilled in the art, it is understood that the definitions are provided for the sake of clarity and are intended to include more examples in addition to the examples provided below.

The term “multi-function device” is a single device or a combination of multiple devices, to perform one or more functions such as, but not limited to, printing, imaging, copying, scanning, and so forth. The multi-function device may include software, hardware, firmware, or a combination thereof. In context of the current disclosure, the multi-function device includes a pre-defined application such as an AR application that secures confidential content of documents while printing, sharing, storing, presenting, accessing or the like. The confidential content is secured such that the confidential content is hidden/masked in the printed document, for example, the printed document does not include the confidential content but includes a predefined code and/or a pre-defined application logo in place of the confidential content. The multi-function device further provides access to the secured printed document including the confidential content, and reproduces the confidential content. The multi-function device includes an AR application for securing the confidential content and/or for providing access to the confidential content of the document.

The term “computing device” refers to a device that is used to automatically execute computer instructions. Examples of a computing device include, but are not limited to, a personal computer, a desktop, a laptop, a mobile phone, a mobile device, a tablet, a Personal Digital Assistant (PDA), a smart-phone or any other device capable of data communication. The computing device may include a pre-defined application such as an AR application to secure confidential content of the document and to further provide access to the confidential content of the document. The computing device can be a mobile device where the AR application executes for securing the confidential content and/or viewing the confidential content.

The term “device” can include, for example, but not limited to, a mobile device, a multi-function device, a printing device, or the like.

The term “document” refers to any artifact that includes content, for example, but not limited to, content that is confidential for users, organizations, nations, or the like, and non-confidential content. Various examples of such confidential documents may be, but are not limited to, cheques, legal documents, bank bonds, research data, contract documents, prescriptions, coupons, tickets, invoices, identity proof, address proof, or disclosure documents. For example, a document submitted for printing can be in digital form, and a document submitted for reproducing can be in physical form such as printed on paper.

The term “securing” means protecting the document, specifically, protecting the confidential content of the document from unauthorized access, viewing, printing, or other actions.

The term “pre-defined application” includes an application such as AR application that allows the user to interact with the document. For example, the pre-defined application allows the user to select content in the document such as confidential content with free hand, for example. The pre-defined application secures confidential content of the document such that the confidential content of the document can be later accessed/viewed using the pre-defined application or printed via the pre-defined application. The pre-defined application can be termed as augmented reality application.

The term “pre-defined code” refers to an n-dimensional code that identifies the confidential content of the document. For example, a pre-defined code can be a bar code, a QR code or other known or later developed codes.

The term “logo” is any predetermined image, such as a small symbol, that the system is programmed to recognize to carry out the steps of the described method. The logo could also be in the form of a machine-readable code, such as a QR code or a bar code, or a predetermined human-readable letter, word, or character. The logo may attain its status as an AR application logo, in whole or in part, by being placed at a predetermined location in, for example, a scanned page image. The logo may have the basic appearance of a machine-readable code, such as a QR or bar code, and be recognized and used as a logo for purposes of this description. In an example, the logo refers to a pre-defined application logo or a pre-defined logo such as AR application logo that helps in identifying a particular AR application used for securing the confidential content of the document.

The term “IR mark” refers to a security mark which is added/printed/embedded in the document to ensure its authenticity/genuineness/originality/confidentiality. In some configurations, the IR mark refers to an invisible security mark.

The term “masking” refers to hiding, removing, deleting, or replacing the confidential content with the pre-defined code and the pre-defined application logo, etc., such that the confidential content is not visible in the printed version.

The present disclosure discloses methods and systems for securing confidential content of a document while printing, sharing, storing, accessing and/or reproducing the document. The methods and systems secure confidential content while allowing the document to be printed. The document is printed such that the confidential content is replaced by a predefined code, and a pre-defined application logo, known as AR application logo. This is done by providing the confidential content through use of a pre-defined application such as an AR viewer. When the document is viewed using the pre-defined application, both the secured confidential content and non-confidential content of the document are viewable/accessible/presented to the user. The methods and systems allow authorized users to access/view the confidential content. The methods and systems further allow users to reproduce the document including the confidential content, and this can be performed at devices with AR-enabled features.

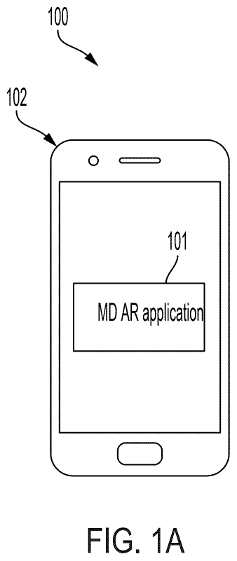

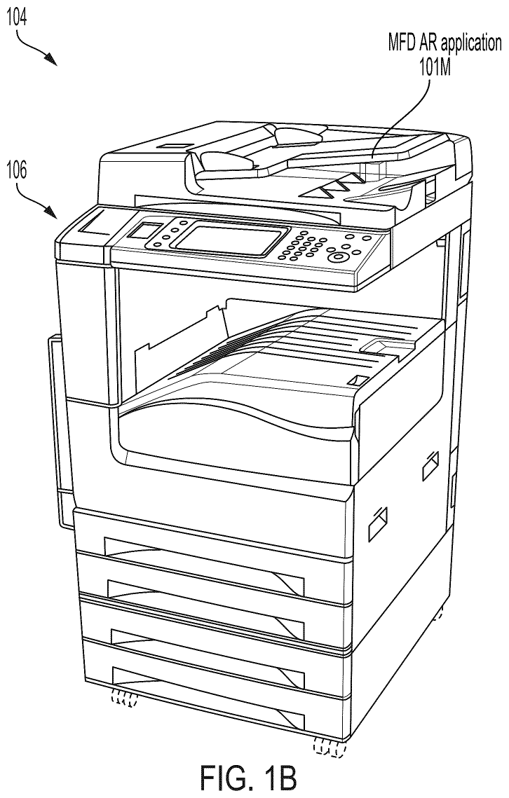

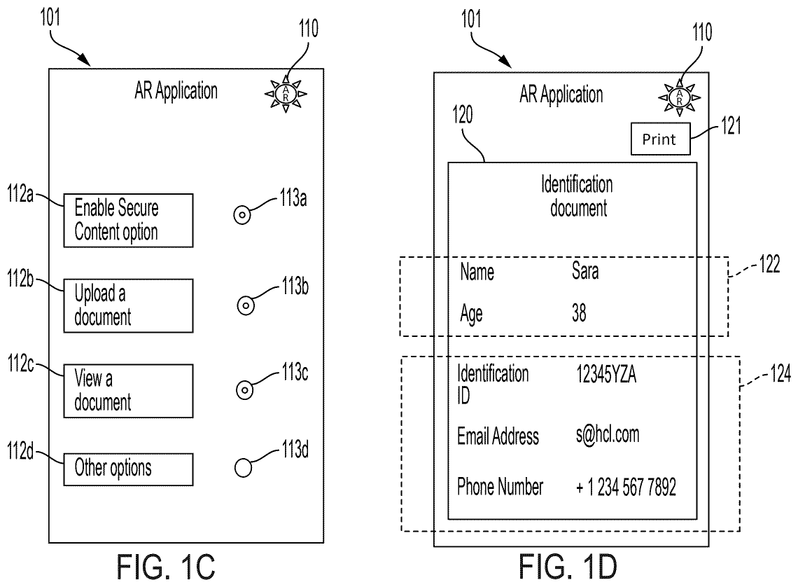

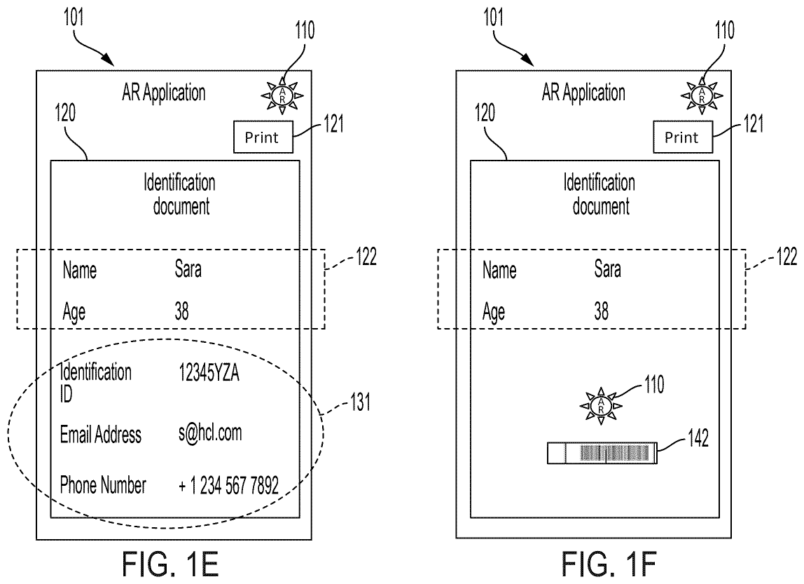

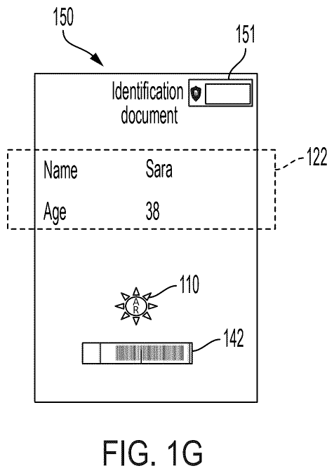

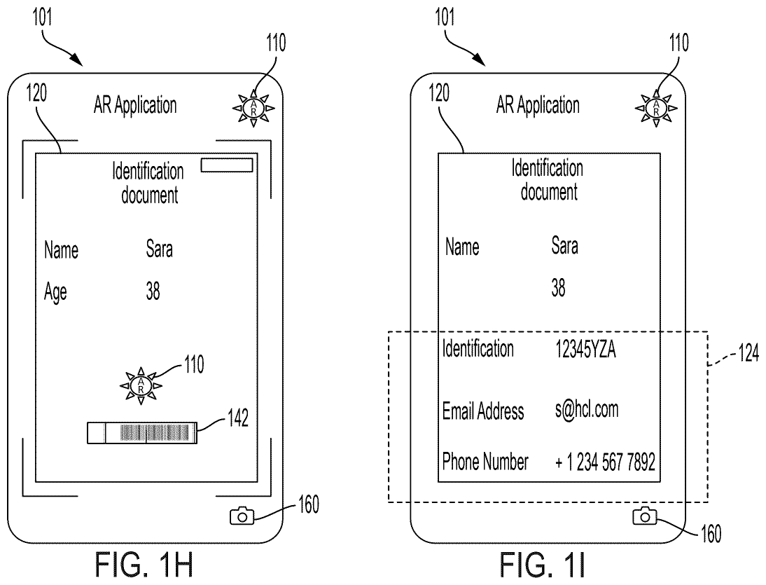

FIG. 1A illustrates environment 100 in which various embodiments of the disclosure can be practiced. The environment 100 includes a computing device such as a mobile device 102. In context of the current disclosure, the mobile device 102 includes a pre-defined application such as an mobile device AR application 101 for securing confidential content and/or for viewing the confidential content. Specifically, the mobile device AR application 101 secures confidential content of the document while printing the document and further allows users to view the confidential content using the mobile device AR application 101.

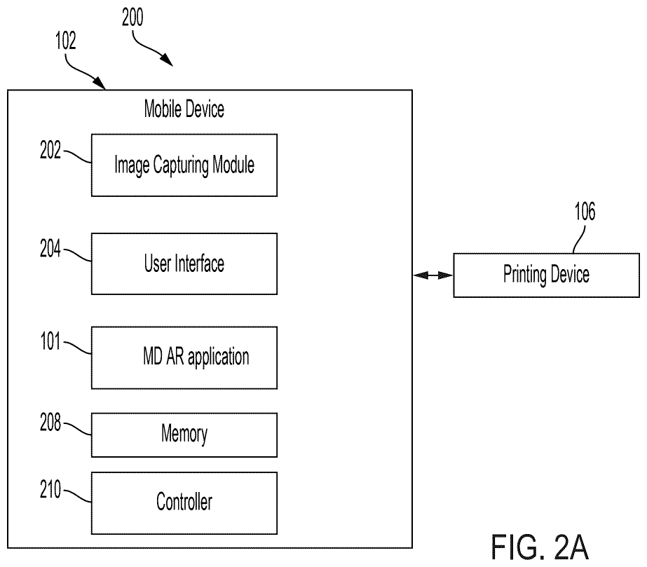

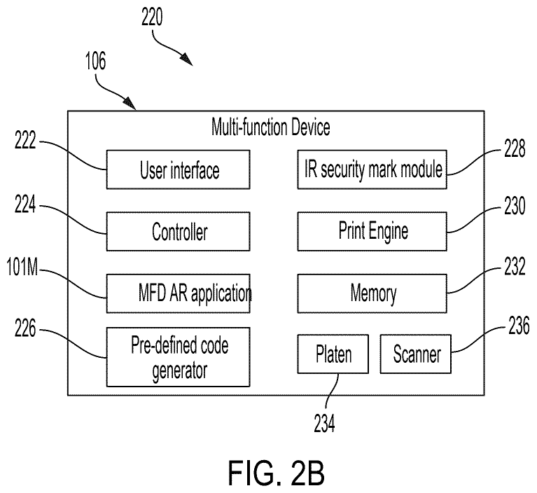

In operation, a user uploads a document in the mobile device AR application 101. The mobile device AR application 101 receives the document. The document can be any document that includes confidential content and non-confidential content. The document can be in any format such as PDF, MS word, other known or later developed formats. The mobile device AR application 101 allows the user to select or indicate the confidential content. Once the confidential content is selected, the mobile device AR application 101 generates a pre-defined code such as a bar code corresponding to the confidential content. The mobile device AR application 101 then removes and stores the confidential content over a cloud location and finally submits the document to a printing device (see FIG. 2A) communicatively coupled to the mobile device 102 and/or the mobile device AR application 101 for printing. The printing device prints an IR security mark while printing the document. The printing device then prints the document such that the printed document includes the non-confidential content, the bar code, the AR application logo, and the IR mark. The printing device prints the bar code and the AR application logo in place of the confidential content while the IR mark is printed to indicate that the document includes the confidential content. The user can collect the printed document and can hand over the printed document to other users such as a bank official, an HR person, a medical person and so on. This way, the other users have access to the document including the non-confidential content of the document but don't have access to the confidential content of the document. Hence, the confidential content is protected in the print path.

Later, if the same user or other users wish to view the confidential content of the document, they use the same mobile device AR application 101 running on their device such as mobile devices. For example, a user uses the mobile device AR application 101 to capture the printed document. The mobile device AR application 101 may have an inbuilt image capturing functionality or may use the camera of the mobile device 102 to capture the printed document such as to capture an image of the printed document. The mobile device AR application 101 first checks if the user is an authorized user before providing access to the confidential content. Based on the check, the mobile device AR application 101 then captures the bar code, retrieves the confidential content corresponding to the captured bar code and presents the confidential content to the user along with the non-confidential content of the document. Specifically, the mobile device AR application 101 generates and presents a complete document including the confidential content and the non-confidential content to the user. This way, the users (including the same user and/or other users) can view the confidential content using the mobile device AR application 101 and are allowed to access the confidential content of the document.

The mobile device AR application 101 and its features can be well understood from snapshots of FIGS. 1C-1I. FIG. 1C shows a mobile device AR application 101 that runs on the mobile device 102. The mobile device AR application 101 includes one or more features such as enable secure content option 112a, upload a document option 112b, view a document 112c, and other options 112d, collectively 112. The selection of the option 112a allows the user to secure the confidential content of the document, for example, the user can select the option via a radio button 113a. Here, the user can enable or disable the secure content option. The option 112b allows the user to upload a document that is to be secured/protected, the user can select the option via a radio button 113b. The option view document 112c allows the user to view the confidential content of the document, and the user can select the option via a radio button 113c. Other options 112d may include interactive selection options, free hand selection options or other options for implementing the present disclosure. The user can select the option via a radio button 113d. The logo of the mobile device AR application 101 is marked as 110. It can be further considered that the user uploads a document such as a personal identification document 120 to the mobile device AR application 101 as shown in FIG. 1D. The document 120 includes confidential content, marked as 124 and non-confidential content, marked as 122. A print option 121 is shown for printing the document. The user can select the confidential content 124 using any interactive option, the selected confidential content is shown via marking 131 in FIG. 1E. The mobile device AR application 101 further masks the confidential content 124 and adds the AR application logo 110 and the pre-defined code such as bar code 142 in place of the confidential content, see FIG. 1F. The user finally selects the print option 121 and submits the document to a printing device communicatively coupled to the mobile device 102. The printing device prints the document. While printing, the printing device embeds and prints an IR security mark on the document. The printed document marked as 150 can be seen in FIG. 1G, where the printed document includes non-confidential content 122, the pre-defined code 142, the AR application logo 110 and the IR security mark 151.

Later at the time of accessing or viewing the printed document 150, the user or another user uses the mobile device AR application 101 running on their devices such as mobile device 102. The mobile device 102 captures an image of the printed document 150 and submits the captured printed document 150 to the mobile device AR application 101 as seen in FIG. 1H. The mobile device AR application 101 includes an image capturing module such as camera 160 for capturing the printed document. The mobile device AR application 101 matches the mobile device AR application logo in the captured document 150, then captures the pre-defined code, retrieves the confidential content, and displays the confidential content of the document for further action such as view, print, and/or share. The mobile device AR application 101 merges the confidential content with the non-confidential content such that the confidential content is placed at its original position. Finally, the mobile device AR application 101 outputs the document 120, see FIG. 1I. The mobile device AR application 101 allows an authorized user to view the confidential content of the document.

FIG. 1A is discussed with respect to a scenario, where the document is submitted for printing via the mobile device AR application 101, and the disclosure is applicable to other scenarios such as securing the confidential content while sharing the document, securing the confidential content while storing the document, and so on. As an example, the mobile device AR application 101 secures the confidential content while sending it to other users. The mobile device AR application 101 can secure the confidential content of the document while storing the document over a cloud location, remote server, a remote database, or the like.

Referring now to FIG. 1B, the multi-function device AR application 101M can execute in environment 104. The environment 104 includes a multi-function device 106 that performs one or more functionalities such as scanning, copying, printing, imaging, or other functionalities. The multi-function device 106 can be a printing device, for example. In some configurations, the multi-function device 106 secures confidential content while printing a document as well as secures the confidential content while reproducing the document. The multi-function device 106 includes a pre-defined application such as multi-function device AR application 101M that secures the confidential content and further provides access to the confidential content while reproducing the document and/or while viewing the document using the mobile device AR application 101.

In some configurations, a user can access the document through the multi-function device 106. The document may be stored at the multi-function device 106 or can be stored at a cloud location or server accessible through the multi-function device 106. Upon selecting the document, the document is submitted to the multi-function device AR application 101M for further processing. The multi-function device AR application 101M secures the confidential content of the document as discussed herein. The multi-function device AR application 101M allows the user to select the confidential content using an interactive option, identifies the confidential content, masks the confidential content, stores the confidential content over a cloud location for later retrieval and/or use, generates a pre-defined code such a bar code corresponding to the confidential content, adds an AR application logo corresponding to the confidential content and submits the document to the multi-function device 106 for printing such as a print engine of the multi-function device 106. The multi-function device AR application 101M adds the pre-defined code and the AR application logo in place of the confidential content. The print engine prints the document such that the printed document includes the non-confidential content, the pre-defined code, the AR application logo, and an IR security mark.

The multi-function device 106 can be used to access the confidential content or to reproduce the document having the confidential content. For example, the user submits the printed document to the multi-function device 106. The multi-function device 106 retrieves the IR security mark from the secured printed document for user's authorization, matches the predefined application logo with a logo of an AR application executing on the multi-function device 106, captures the pre-defined code to identify and retrieve the corresponding confidential content, and merges the retrieved confidential content with the non-confidential content of the document to output a document that includes the confidential and the non-confidential content. The multi-function device 106 reproduces the document including the confidential content and non-confidential content. The reproduced document may not include the IR mark. The reproduced document can be a scanned document in the form of a digital version or a copied document in physical form.

A version of the AR application can execute on mobile devices, printing devices, multi-function devices and so on. For example, the user can use the mobile device AR application 101 executing on the mobile device for securing the confidential content and can submit the document for printing through his mobile device. For accessing/viewing the confidential content, any authorized user can use an AR application for viewing or accessing the content. In another example, the user can use the multi-function device AR application 101M executing on a multi-function device 106 for securing the confidential content and the document gets directly printed at the multi-function device 106. A mobile device AR application 101 executing on a mobile device can be used for viewing/accessing the confidential content. In another example, a user can use a multi-function device AR application 101M on the multi-function device 106 for reproducing the document including the confidential content. The reproduced document can be a scanned document (digital version) or a copied document (physical form).

The multi-function device AR application 101M receives the document including the confidential content and non-confidential content. The multi-function device AR application 101M further allows a selection or indication the confidential content via one or more interactive options such free hand option, selection box option or the like. The multi-function device AR application 101M then separates the confidential content from the non-confidential content and stores the confidential content over a cloud. The multi-function device AR application 101M masks the confidential content using one or more ways. The multi-function device AR application 101M generates a pre-defined code corresponding to the confidential content and adds the pre-defined code corresponding to location of the confidential content of the document for accessing the confidential content using the multi-function device AR application 101M. The multi-function device AR application 101M adds the AR application logo for identifying the augmented reality application used for securing the confidential content for later accessing the confidential content. Finally, the multi-function device AR application 101M submits/sends the document for printing such that printed document includes the non-confidential content, the predefined code and the AR application logo corresponding to the confidential content of the document.

According to further example embodiments here, an AR application allows users to view the confidential content. It can be considered that the mobile device AR application 101 executes on a device such as a mobile device. The mobile device AR application 101 receives the printed document including the non-confidential content, an IR security mark, the predefined code, and the AR application logo. The mobile device AR application 101 detects the AR application logo in the printed document and matches with its logo. Upon detecting, the mobile device AR application 101 captures the pre-defined code. The mobile device AR application 101 retrieves the confidential content corresponding to the captured pre-defined code. The mobile device AR application 101 displays the confidential content to the user, thereby allowing users to view the confidential content. Before displaying, the mobile device AR application 101 merges the retrieved confidential content with the non-confidential content of the document to output a complete document.

Authorized users can access the confidential content using an AR application. The user's authorization can be performed based on their login credentials of the AR application, other credentials such as user ID, employee ID, username, secret code, password other known or later developed methods. The list of authorized users can be defined or pre-defined by an organization or an admin of the organization. The authorized user information can be embedded in the pre-defined code, IR security mark or can be sent along while submitting the document for printing or can be pre-stored at the mobile device 102, the multi-function device 106 and/or the AR application.

FIG. 2A illustrates a system 200 for securing confidential content of a document while printing the document. The system 200 includes a mobile device 102 communicatively coupled to a printing device or multi-function device 106 via any known network or later developed network. The mobile device 102 includes a mobile device image capturing module 202 such as camera, a mobile device user interface 204, a mobile device AR application 101, and a mobile device memory 208. The mobile device AR application 101 includes a mobile device controller 210. The mobile device components 202, 204, 208, 210, and 101 are electronically coupled and communicate among themselves.

In operation, a user uploads a document to the mobile device AR application 101, where the document includes confidential content and non-confidential content. The document may be stored in the mobile device memory 208 or can be accessed via email, cloud, server, or other way. The mobile device AR application 101 receives the document including the confidential content and non-confidential content. The mobile device AR application 101 allows a user to select or indicate the confidential content via one or more interactive options. The interactive options are displayed to the user via the mobile device user interface 204. The mobile device controller 210 identifies the confidential content based on the user input. The mobile device controller 210 masks the confidential content using one or more ways. The mobile device controller 210 generates a pre-defined code corresponding to the confidential content of the document for accessing the confidential content using the mobile device AR application 101. The mobile device controller 210 adds the AR application logo that is used for identifying the mobile device AR application 101 used for securing the confidential content for accessing the confidential content. The mobile device controller 210 sends the document including the non-confidential content, the pre-defined code, and the AR application logo to a multi-function device 106 for printing.

The user accesses the confidential content using the mobile device AR application 101 executing on a mobile device 102. For example, the user opens the mobile device AR application 101 to capture the printed document. The mobile device image capturing module 202, such as camera of the mobile device 102 captures an image of the printed document and the mobile device controller 210 sends the captured document to the mobile device AR application 101. In some configurations, the mobile device AR application 101 may include an inbuilt image capturing module to capture the printed document and other details. The mobile device AR application 101 receives the printed document including the non-confidential content, the IR security mark, the pre-defined code, and the AR application logo.

The mobile device controller 210 of the mobile device AR application 101 detects the AR application logo given in the printed document and matches the AR application logo with logo of the mobile device AR application 101 or pre-stored logos. The mobile device controller 210 captures the pre-defined code, upon detecting the AR application logo in the printed document. For example, an inbuilt camera captures the pre-defined code such as a bar code. Based on the captured bar code, the mobile device controller 210 identifies and retrieves confidential content corresponding to the captured pre-defined code. The mobile device controller 210 displays the confidential content to the user via the mobile device user interface 204. Before displaying the confidential content, the mobile device controller 210 merges the confidential content with the non-confidential content such that the confidential content is positioned/overlaid at its original position. The mobile device AR application 101 allows access to the confidential content.

The mobile device memory 208 may store relevant information for implementing the present disclosure such as user details, authorized user details, logos, documents, or the like. The mobile device user interface 204 presents the document, confidential content, messages, and notifications to the user. The mobile device user interface 204 may receive an input from the user such as selection of the confidential content or the like. The mobile device controller 210 may incorporate functionalities to secure confidential content and/or to provide access to the confidential content, or these functionalities can be directly incorporated in the mobile device AR application 101.

Referring now to FIG. 2B, system 220 for securing confidential content of a document while printing and/or while reproducing the document including the confidential content is shown. The system 220 includes a multi-function device 106 including a multi-function device user interface 222, a multi-function device controller 224, a pre-defined application such as a multi-function device AR application 101M, a pre-defined code generator 226, a IR security mark module 228, a print engine 230, a multi-function device memory 232, a platen 234 and a scanner (or copier) 236. Some system components 222-236 may be used for securing the confidential content while printing such as the multi-function device user interface 222, the multi-function device controller 224, the print engine 230, and the multi-function device memory 232. Some system components may be used for reproducing the document including the confidential content such as platen 234 and scanner/copier 236. The components 222-236 and 101M are electronically coupled and communicate among themselves. The multi-function device 106 may be communicatively coupled to other devices such as, but not limited to, a computing device or a print driver of the computing device.

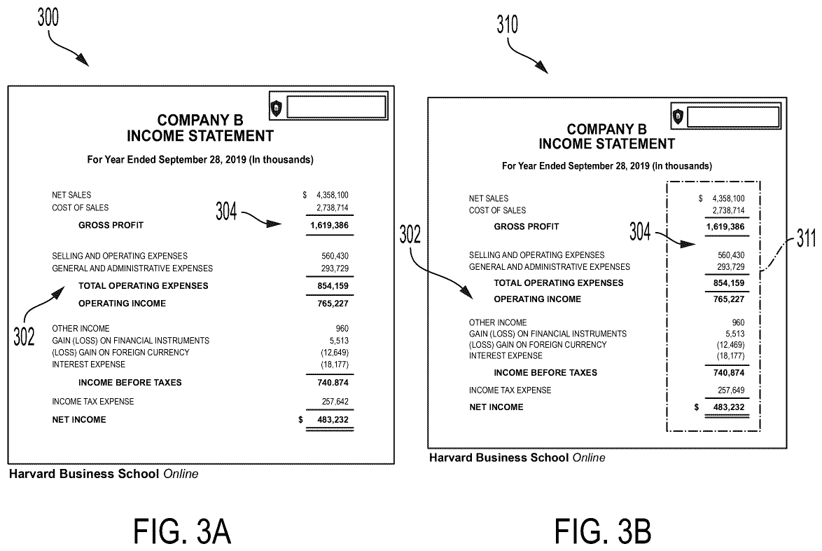

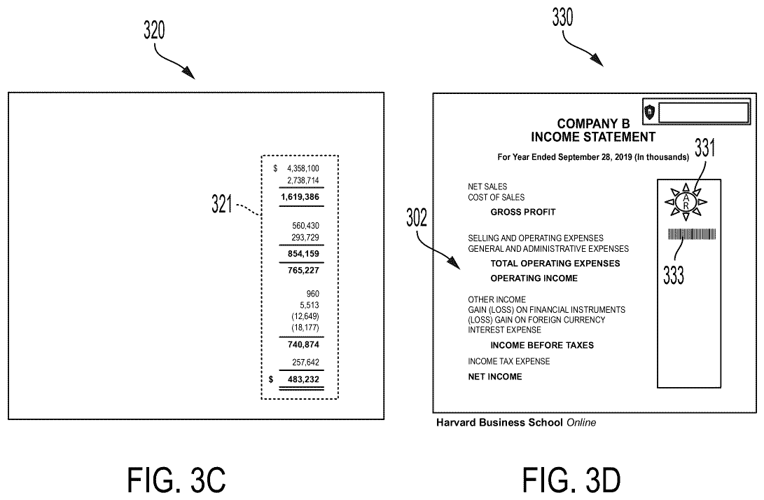

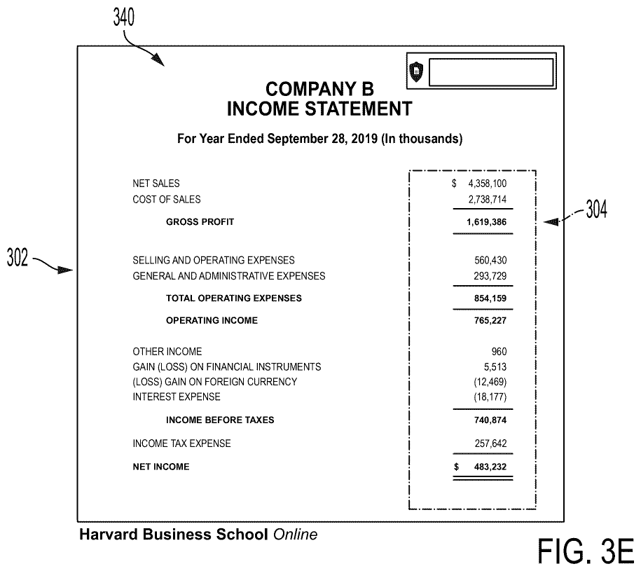

Referring now to FIG. 3A, operationally, a user has a document for printing that is to be submitted to another user, say, a bank official. The document 300 includes confidential content 304 and non-confidential content 302. Before giving the printed document to another user i.e., to the bank official, the user secures the confidential content. The user opens the multi-function device AR application 101M on the multi-function device 106. The user logs into the multi-function device AR application 101M and performs authentication before using the multi-function device AR application 101M. The user can log in based on one or more credentials such as username, user ID, employee name, employee ID, email address, phone number, biometric login, or a combination thereof. Upon successful login, the multi-function device AR application 101M allows the user to proceed. The multi-function device AR application 101M provides one or more options to the user for securing the confidential content. For example, the multi-function device AR application 101M provides an option to upload a document. The user uploads the document for printing and for securing the confidential content of the document. The multi-function device AR application 101M includes an upload option that can be selected by the user via click button, touch button, or the like. In some examples, the user can submit the document from a computing device via a print driver. The multi-function device AR application 101M receives the document.

Once the document is uploaded, the multi-function device AR application 101M analyzes the document and provides an option to the user to select confidential content in the document. The multi-function device AR application 101M, for example, displays a preview of the document that allows the user to select the confidential content. One or more options are included in the multi-function device AR application 101M such as selection box, free hand selection, touch selection and so. The user can select the confidential content using any of the given options. For example, the user can select the confidential content simply using a touch selection. In some implementations, the multi-function device AR application 101M can automatically select the confidential content and the user can confirm the selection of the confidential content.

Referring now to FIG. 3B, a snapshot 310 is shown in which the user selects the confidential content 304 via a selection box 311. The multi-function device AR application 101M separates the confidential content from the non-confidential content in the document. As an example, the multi-function device AR application 101M extracts the confidential content from the document and triggers the pre-defined code generator 226 to generate a pre-defined code such as a bar code corresponding to the confidential content. The extracted confidential content 321 is shown in the snapshot 320 in FIG. 3C. The multi-function device AR application 101M extracts the confidential content as an image. The pre-defined code generator 226 generates a bar code corresponding to the confidential content and shares the same with the multi-function device AR application 101M. The bar code represents identification of the confidential content of the document. The multi-function device AR application 101M requests the multi-function device controller 224 to store the confidential content over a cloud location or a server location for later retrieval and/or use. The multi-function device controller 224 stores the confidential content along with the bar code on the server such that they can be retrieved later and further communicates to the multi-function device AR application 101M. This way, the confidential content is successfully extracted and stored over the cloud location.

The multi-function device AR application 101M masks the confidential content in the document such that the confidential content is not visible in the document. For example, the multi-function device AR application 101M removes or deletes the confidential content from the document. In another example, the multi-function device AR application 101M hides the confidential content with some background, color, white space, or the like such that it is not visible in the printed version. Once the confidential content is masked, the multi-function device AR application 101M adds the AR application logo in the document and the bar code in the document. For example, the multi-function device AR application 101M places the bar code and the AR application logo in the place of the confidential content. The multi-function device AR application 101M may place the bar code and the AR application logo around the location of the confidential content. The multi-function device AR application 101M prepares the document for printing without including the confidential content. The user initiates print by pressing a print button given in the multi-function device AR application 101M or via print options included in the multi-function device AR application 101M as shown in FIGS. 1E and 1F. In other configurations, the multi-function device AR application 101M automatically initiates print action. In such configurations, the multi-function device AR application 101M triggers the multi-function device controller 224 to print the document. For printing, the multi-function device AR application 101M sends the bar code, the document including the non-confidential content, the AR application logo used while printing the document. The multi-function device controller 224 receives the details from the multi-function device AR application 101M. The AR application logo indicates the application that is used to secure the confidential content. The bar code indicates a number or an identification corresponding to the confidential content. The AR application logo can be included at any suitable place in the document. For example, the AR application logo can be included in the top right corner of the document. The bar code can be included at suitable place in the document such as in place of the confidential content. The AR application logo and the bar code can be included at a suitable place in the document. In FIG. 3D, the snapshot 330 shows the document 300 with non-confidential content 302 and the masked confidential content. The document 300 further includes the bar code 333 and the AR application logo 331 in place of the confidential content. The document 300 is prepared by the multi-function device AR application 101M after executing the processes for securing the confidential content.

The multi-function device AR application 101M sends the document including the bar code and the AR application logo to the multi-function device controller 224. The multi-function device controller 224 triggers the print engine 230 for printing the document. The IR security mark module 228 embeds an IR security mark in the document. The multi-function device controller 224 instructs the print engine 230 to print the IR mark while printing the document. The print engine 230 prints the document such that the printed document includes the non-confidential content along with the IR mark, the bar code, and the AR application logo. The system 220 secures the confidential content in the print path by printing the non-confidential content and by masking the confidential content. The user can collect the printed document and share it with another user. In some cases, the other user views the confidential content for validation, verification, or other purposes. In such cases, the other user can use the same multi-function device AR application 101M to view the confidential content.

To access the confidential content, an AR application running on a device such as mobile device, the computing device, or the multi-function device. The user logs in into an AR application using on one or more credentials such as username, user ID, employee ID, password, passcode, phone number, email address or a combination thereof. The user is authenticated before access is provided to the AR application and its functionalities. If the user is authorized to access the AR application, the system proceeds forward. Otherwise, the system does not proceed forward. Upon successful login, the AR application allows the user to view the application and shows one or more features.

In operation, when the multi-function device AR application 101M is executing in the multi-function device 106, the user submits the printed document on a platen 234. For example, the user can place the printed document on the platen 234 for scanning and can initiate scanning. The scanner 236 scans the document by capturing an image of the printed document and generates scanned data/image data. The scanner 236 generates scanned data corresponding to the printed document and passes the generated data to the multi-function device controller 224 for further processing. In some cases, the multi-function device controller 224 identifies the IR security mark and retrieves the IR security mark from the scanned data to authorize the user. For example, the IR security mark may include user details so that the multi-function device controller 224 may retrieve the user details embedded in the IR security mark for authorization. For example, the multi-function device controller 224 checks whether the information included in the IR security mark matches with the credentials of the logged-in user. The multi-function device controller 224 then matches the AR application logo with a logo of the multi-function device AR application 101M running on the multi-function device 106 or logos stored at the multi-function device 106. When a match is found, the multi-function device controller 224 passes the processed data/scanned data to the multi-function device AR application 101M.

In some implementations, the scanner 236 may directly send the captured image of the printed document to the multi-function device AR application 101M for further processing. In such multi-function device AR application 101M may check whether the printed document includes the AR application logo. If the AR application logo is found, the multi-function device AR application 101M checks whether the AR application logo matches the AR application logo stored in the multi-function device memory 232. Here, the multi-function device AR application 101M matches the AR logo in the printed document with the AR application logo. If it matches, the multi-function device AR application 101M proceeds forward. The multi-function device AR application 101M obtains the bar code from the scanned data. The bar code includes the server location where the confidential content is stored. The multi-function device AR application 101M accesses the cloud location, identifies and retrieves confidential content corresponding to the bar code. Specifically, the multi-function device AR application 101M accesses the cloud location, searches the cloud location for the confidential content based on the bar code. The multi-function device AR application 101M retrieves the confidential content from the cloud location and merges the retrieved confidential content with the non-confidential content. The confidential content is merged such that a document is obtained, where the document includes the confidential content at its original location and the non-confidential content. Specifically, the multi-function device AR application 101M identifies the location of the confidential content, removes the bar code, and adds the confidential content to its location. The multi-function device AR application 101M overlays the extracted confidential content in the document based on its location/extracted coordinate information. The multi-function device AR application 101M passes the merged content to the multi-function device controller 224 to generate a final output file, for example, the multi-function device controller 224 implements image processing techniques to generate a complete document. This way, a document including the non-confidential content and the confidential content is presented to the user via the multi-function device AR application 101M. A document/output including the confidential content 304 and non-confidential content 302 is shown in the snapshot 340 of FIG. 3E. The multi-function device 106 may further reproduce the document including the confidential content and the non-confidential content in physical form or digital form. The reproduced document may not have the IR mark. This way, the system 220 does not restrict authorized users from reproducing the document including the confidential content.

The multi-function device memory 232 may store relevant information for implementing the present disclosure such as user details, authorized user details, logos, documents, or the like. The multi-function device user interface 222 presents the document, confidential content, messages, and notifications to the user. The multi-function device user interface 222 may receive an input from the user such as selection of the confidential content or the like. The multi-function device controller 224 may incorporate the functionalities to secure confidential content and/or to provide access to the confidential content or these functionalities can be directly incorporated in the multi-function device AR application 101M. The multi-function device controller 224 may be a part of the multi-function device AR application 101M without limiting its scope.

The mobile device user interface 204 and the multi-function device user interface 222 of the mobile device 102 and the multi-function device 106, respectively, as discussed herein can be replaced by a user interface of the mobile device AR application 101 or the multi-function device AR application 101M.

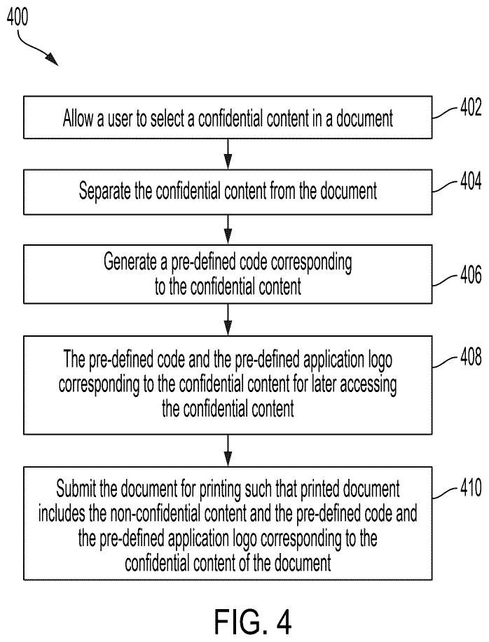

FIG. 4 is a method flowchart 400 for securing confidential content of a document such that the confidential content is not visible in a printed version. The confidential content is secured while printing the document or otherwise while sharing the document or storing the document. The method 400 can be implemented in a pre-defined application executing on a device such as, for example, but not limited to, multi-function device, a mobile device, or a computing device. One non-limiting example of the pre-defined application is mobile device AR application 101. The method 400 is described herein with respect to printing, but it is understood that the method 400 can be implemented in other scenarios as well.

The method 400 begins when a user wishes to print a document without printing confidential content of the document. The user initiates the AR application on the device such as multi-function device and uploads the document for printing in the AR application. The AR application receives the document, the document includes confidential content and non-confidential content. The document can be any document such as address proof, identity proof, medical documents, official documents, personal documents, financial documents, bank statements, or the like. The document can be in any format such as, for example, but not limited to, PDF, MS Word, or other known or later developed format. When the user uploads the document to the AR application, a pre-defined feature such as secure confidential content feature is automatically enabled to secure the confidential content of the document. In some configurations, the user decides whether to enable the secure confidential content feature. Once the document is uploaded to the AR application, the method 400 proceeds forward.

At 402, the user is allowed to select the confidential content in the document. For example, one or more selection boxes can be provided via the user interface of the AR application. The user can select a selection box to select the confidential content. In other examples, the user can directly select the confidential content using free hand option. In other implementations, the confidential content can be selected automatically by the AR application. In some implementations, a preview of the document is shown to select the confidential content in the AR application. Once the confidential content is selected or indicated, position and/or coordinates of the confidential content are identified by the AR application. For example, x and y coordinate information is identified by the AR application and other coordinate information such height may be identified by the AR application.

Once the confidential content is selected, at 404, the confidential content is separated from the non-confidential content. For example, the confidential content is extracted from the document using one or more known or later developed algorithms. The extracted confidential content can be stored over a cloud location for later retrieval and/or use. Along with the confidential content, coordinate information and/or position information about the confidential content is stored over the cloud location. Post storing, a pre-defined code such as bar code is generated corresponding to the confidential content of the document at 406. The bar code is associated with the confidential content.

The confidential content may be masked in the document. For example, the confidential content can be hidden with a pre-defined pattern such that the confidential content is not visible. In other cases, the confidential content can be removed from the document. In further examples, the confidential content can be replaced with white color box. Thereafter, one or more codes/logos are embedded or added in the document at 408, the pre-defined code and a predefined application logo are added corresponding to the confidential content for later accessing the confidential content. The pre-defined code and the AR logo are added around the location of the confidential content. The codes can be embedded in a corner of the document. The codes can be embedded in the place where the confidential content is included. For example, one code such as a bar code can be added in the document that identifies the confidential content of the document. In another example, an AR application logo can be added so that the AR application can be recognized. At 410, the document is submitted for printing, where the printed document includes the non-confidential content and the bar code and the AR application logo corresponding to the confidential content. The document for printing is submitted at a printing device such as multi-function device. The document is printed such that printed document includes the non-confidential content, the pre-defined application logo, the bar code, and an IR security mark. While printing the document, the IR security mark is embedded and printed in the document. The IR security mark can be printed in any corner of the document such as top left, top right, bottom left, bottom right or other places in the document. The IR security mark indicates that the document or a portion of the document is confidential and further restricts reproducing the document and/or its content including the confidential content/non-confidential content. For example, the presence of the IR security marks allows authorized users to reproduce the document with the confidential content. This way, the confidential content is protected in the print path. The printed document can be given to a user such as a bank official for later retrieval and/or use.

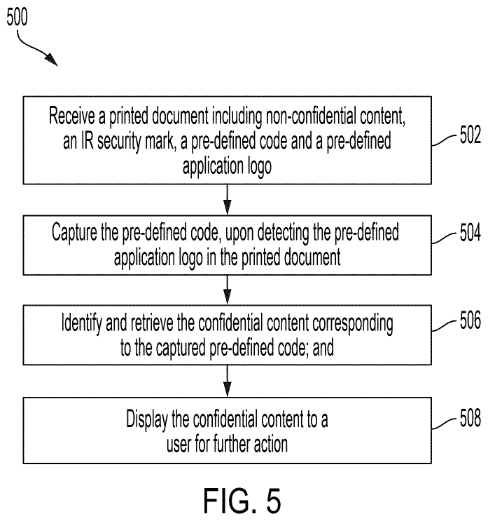

FIG. 5 is a method flowchart 500 for providing access to a secured printed document. Specifically, the method 500 allows a user to access confidential content corresponding to a secured printed document, the printed document includes non-confidential content, an IR security mark, a pre-defined code and an AR application logo. The method 500 can be implemented at a pre-defined application running on a device a mobile device or a computing device. One non-limiting example of the pre-defined application is an AR application. The method 500 is described with viewing as an example, but it is understood that the method 500 can be implemented in other scenarios as well.

At 502, the printed document including the non-confidential content, IR mark, the pre-defined code and the pre-defined logo is received. The document is captured to identify if there is any application logo in the document and if so, the pre-defined application logo is extracted. Then, the extracted application logo is matched with the logo of the AR application or AR application logos as stored. The AR application logo matching is just one way, but there can other possibilities to match the AR application. If there is a match, the method 500 proceeds forward. Before proceeding further, the user is authenticated. For example, it is checked whether the user is authorized to access the confidential content. The user can be authenticated based on one or more credentials such as username, password, user ID, employee ID, passcode, email address, phone number or a combination thereof. At 504, the pre-defined code such as bar code is captured upon detecting the AR application logo. The bar code is captured to identify and retrieve the confidential content stored over the cloud location at 506. While retrieving, the location/coordinate information about the confidential content is also retrieved. At 508, the retrieved confidential content is displayed to a user for further action such as view, share, print and other. Before displaying the confidential content to the user, the confidential content is merged with the non-confidential content of the document such that the confidential content is placed over its original location/position. For example, the confidential content is overlaid as an image based on the retrieved coordinate information of the confidential content. This way, the confidential content is retrieved and presented to the user. For example, the confidential content is put back to its original place. A document is generated including the confidential and non-confidential content of the document. The document is presented to the user for further action such as print, view, share or other actions.

The methods and systems describe various implementations of securing confidential content and/or providing access to the confidential content. Any blocks, processes discussed in figures above can be added and/or modified for implementation purposes.

The present disclosure discloses methods and systems for securing confidential content while printing and/or storing a document. The methods and systems further secure confidential content when the document is accessed and/or when the document is presented to a different user. The methods and systems offer additional document security and provide data security in print path also. The methods and systems further prevent data leakage or access to the confidential document in the printed version. The methods and systems further provide additional features to select the confidential content of the document. The methods and system enhance user experiences.

The present disclosure proposes an AR-enabled IR workflow to address the existing concerns and further enhances print document security. The disclosure allows authorized users to view the document, both confidential and non-confidential content, using the AR application. For example, the disclosure prints the document with non-confidential content and prints the predefined application logo and document identification number as a barcode in place of the confidential content.

The present disclosure allows the user to select the partial document content as confidential content, thereby adding flexibility for the user. The disclosure provides a simple, user friendly and efficient approach to secure the confidential content as well to later view the confidential content by the same user or a different user.

The methods and systems secure confidential content such that it is protected from printing, reproducing, and seen. The methods and systems handle security concerns in the print path.

The disclosure proposes methods and systems for securing a confidential document, including when the document to be printed. This is done by placing the content of the document that is confidential within a cloud server such that it can be viewed while using AR viewer/application. The document that is printed does not contain any confidential data, just the bar code/AR logo/IR security mark. When the document is viewed using the AR application, both secured confidential content and non-confidential content of the document are viewable.

The present application proposes the use of an AR application for masking/hiding the confidential content of the document and later allowing the users to view the hidden confidential content using the augmented reality application.

The AR application can reside on mobile devices, multi-function devices, or other devices for securing/protecting the confidential content of the document. The AR application allows users to easily interact with the document for selecting or indicating the confidential content via one or more interactive options. One such option is the freely drawn option. For example, the AR application allows the user to select the confidential content using free hand.

While reproducing, the AR application matches the pre-defined logo in the printed document with logo of the AR application used for securing. If matched, the AR application proceeds further, else the AR application ignores the printed document.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. In the configurations described herein, the method may be considered to be implemented in the system described herein and/or the apparatus and/or any electronic device (not shown).

In an aspect, a method for securing confidential content of a document while printing the document, comprises receiving the document for printing, comprising the confidential content and non-confidential content; allowing a user to select or indicate the confidential content in the document; masking the confidential content using one or more ways; adding a predefined code corresponding to location of the confidential content of the document for later accessing the confidential content using a pre-defined application; adding a pre-defined logo around the location of the confidential content for later accessing the confidential content using the pre-defined application; and submitting the document for printing such that printed document comprises the non-confidential content and the pre-defined code and the pre-defined logo corresponding to the location of the confidential content of the document.

In an aspect, the method further comprises separating the confidential content from the non-confidential content of the document.

In an aspect, the method further comprises storing the confidential content over a cloud location for later retrieval and/or use.

In an aspect, the method further comprises generating the pre-defined code corresponding to the confidential content of the document.

In an aspect, the method further comprises adding and printing an IR security mark while printing the document.

In an aspect, the method wherein the printed document comprises the non-confidential content and the pre-defined code and the pre-defined logo in the place of the confidential content.

In an aspect, the method further comprises receiving the printed document comprising the non-confidential content, an IR security mark, the pre-defined code, and the pre-defined logo.

In an aspect, the method further comprises capturing the pre-defined code upon detecting the pre-defined logo in the printed document.

In an aspect, the method further comprises identifying and retrieving the confidential content corresponding to the captured pre-defined code.

In an aspect, the method further comprises merging the retrieved confidential content with the non-confidential content of the document such that the confidential content is displayed for further action.

In an aspect, the method further comprises outputting a complete document such that the complete document comprises the retrieved confidential content and the non-confidential content for view, share and/or, print.

In an aspect, a method for providing access to a secured printed document at a device comprises: wherein the device comprises an image capturing module, wherein the secured printed document comprises non-confidential content, an IR security mark, a pre-defined code, and a pre-defined logo, receiving the printed document comprising the non-confidential content, the IR security mark, the pre-defined code and the pre-defined logo; capturing the pre-defined code, upon detecting the pre-defined logo in the printed document; identifying and retrieving confidential content corresponding to the captured pre-defined code; and providing access to the confidential content for further action.

In an aspect, the method further comprises matching the pre-defined logo before retrieving the confidential content.

In an aspect, the method further comprises merging the identified confidential content with the non-confidential content of the document to output a complete document.

In an aspect, an augmented reality application running on a device for securing confidential content of a document is configured for: receiving the document comprising the confidential content and non-confidential content; allowing a user to select or indicate the confidential content via one or more interactive options; and executing one or more processes for securing the confidential content, comprising: masking the confidential content using one or more ways; adding a pre-defined code corresponding to the confidential content of the document for later accessing the confidential content using the augmented reality application; and adding a logo for identifying an augmented reality application that is used for securing the confidential content for later accessing the confidential content.

In an aspect, the augmented reality application is further configured for sending the document for printing such that printed document comprises the non-confidential content, the pre-defined code and the logo corresponding to the confidential content of the document.

In an aspect, the augmented reality application is further configured for generating the pre-defined code corresponding to the confidential content of the document.

In an aspect, the augmented reality application is communicatively coupled to a printing device, wherein the printing device prints the document such that the printed document comprises the non-confidential content, an IR security mark, the pre-defined code and the logo.

In an aspect, the augmented reality application is further configured for receiving the printed document comprising the non-confidential content, an IR security mark, the pre-defined code, and the logo.

In an aspect, the augmented reality application is further configured for capturing the pre-defined code, upon detecting the logo in the printed document.

In an aspect, the augmented reality application is further configured for retrieving the confidential content corresponding to the captured pre-defined code.

In an aspect, the augmented reality application is further configured for merging the retrieved confidential content with the non-confidential content of the document to output a complete document.

In an aspect, an augmented reality application running on a device for providing access to a secured printed document is configured for: wherein the printed document comprises non-confidential content, an IR security mark, a pre-defined code, and a logo, receiving the printed document comprising the non-confidential content, the IR security mark, the pre-defined code and the logo; capturing the pre-defined code, upon detecting the logo in the printed document; identifying and retrieving confidential content corresponding to the captured predefined code; and displaying the confidential content to an authorized user for further action.

In an aspect, the augmented reality application is further configured for merging the retrieved confidential content with the non-confidential content of the document to output a complete document.

In an aspect, a mobile device for securing confidential content of a document comprises an augmented reality (AR) application configured for: receiving the document comprising the confidential content and non-confidential content; allowing a user to select or indicate the confidential content via one or more interactive options; masking the confidential content using one or more ways; adding a pre-defined code corresponding to the confidential content of the document for later accessing the confidential content using the augmented reality application; and adding an AR application logo for identifying an augmented reality application that is used for securing the confidential content for later accessing the confidential content.

In an aspect, a mobile device for providing access to a secured printed document comprising an augmented reality (AR) application configured for: wherein the printed document comprises non-confidential content, an IR security mark, a pre-defined code, and an AR application logo, receiving the printed document comprising the non-confidential content, the IR security mark, the pre-defined code and the AR application logo; capturing the pre-defined code, upon detecting the AR application logo in the printed document; identifying and retrieving confidential content corresponding to the captured pre-defined code; and providing access to the confidential content for further action.

In an aspect, a multi-function device for securing confidential content of a document while printing the document comprising: an augmented reality (AR) application running on the multi-function device configured for: receiving the document comprising the confidential content and non-confidential content for printing; allowing a user to select or indicate the confidential content; masking the confidential content using one or more ways; and adding a pre-defined code corresponding to the confidential content of the document for later accessing the confidential content; adding a pre-defined application logo for identifying an augmented reality application that is used for securing the confidential content; and submitting the document for printing; and a print engine for printing the document such that the printed document comprises the non-confidential content, the pre-defined code and the pre-defined application logo corresponding to the confidential content of the document.

In an aspect, the multi-function device wherein the augmented reality application is further configured for generating the pre-defined code corresponding to the confidential content of the document.

In an aspect, a multi-function device for providing access to confidential content corresponding to a secured printed document, wherein the secured printed document comprises non-confidential content, an IR security mark, a pre-defined code, and a pre-defined application logo, the multi-function device comprises: a platen for: receiving the secured printed document comprising the non-confidential content, the IR security mark, the pre-defined code and the predefined application logo; a controller for: retrieving the IR security mark from the secured printed document; and matching the pre-defined application logo with a logo of an augmented reality (AR) application running on the multi-function device; and the Augmented Reality application for: capturing the pre-defined code to identify and retrieve the corresponding confidential content; and merging the retrieved confidential content with the non-confidential content of the document to output a complete document comprising the confidential and the non-confidential content.

In an aspect, the multi-function device further comprises reproducing the complete document comprising the confidential content and non-confidential content.

In an aspect, the multi-function device where the IR security mark comprises authorized user's details.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by computer components, including a central processing unit (CPU), memory storage devices for the CPU, and connected display devices. These descriptions and representations are the means used by those skilled in the data processing arts to convey the substance of their work to others skilled in the art. An algorithm is generally perceived as a self-consistent sequence of steps leading to a desired result. The steps are those performing physical manipulations of physical quantities. These quantities can take the form of electrical or magnetic signals capable of being stored, transferred, combined, compared, and otherwise manipulated.

It should be understood that these and similar terms are to be associated with the appropriate physical quantities and are merely convenient labels applied to these quantities. Unless specifically stated otherwise, as apparent from the discussion herein, it is appreciated that throughout the description, discussions utilizing terms such as receiving, storing, retrieving, printing, merging, adding, embedding, securing, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The systems and methods described herein relate to an apparatus for performing the operations discussed herein. This apparatus may be specially constructed to perform operations in accordance with embodiments of the present disclosure. A computer program performing the operations may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and coupled to a computer system bus.

The methods illustrated throughout the specification may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

The terminology used herein is for the purpose of describing particular embodiments and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for securing and accessing confidential content of an original document, the method comprising:
receiving the original document;
receiving an indication of the confidential content in the original document;
amending the original document by masking the confidential content in the original document and adding a code to the original document at a location of the masked confidential content; and
outputting the amended document.

2. The method of claim 1, further comprising:
adding a logo around the location.

3. The method of claim 2, further comprising:
receiving the outputted document;
detecting the logo in the outputted document;
accessing the code; and
identifying and retrieving the confidential content corresponding to the code.

4. The method of claim 3, further comprising:
matching the logo before retrieving the confidential content.

5. The method of claim 3, further comprising:
recreating the original document by merging the retrieved confidential content into the outputted document.

6. The method of claim 1, further comprising:
storing the confidential content over a cloud location.

7. The method of claim 1, further comprising:
generating the code.

8. The method of claim 1, further comprising:
adding an IR security mark to the amended document.

9. The method of claim 1, wherein outputting the amended document comprises:
one or more of printing the amended document or displaying the amended document.

10. The method of claim 1, further comprising:
receiving the original document and the outputted document by an image capturing module.

11. A computer system for executing an augmented reality (AR) application, the AR application securing and accessing confidential content of an original document, the computer system comprising:
a hardware processor;
a non-volatile storage medium storing instructions that when executed by the hardware processor perform operations comprising:
receiving the original document;
receiving an indication of the confidential content in the original document;
amending the original document by masking the confidential content in the original document and adding a code to the original document at a location of the masked confidential content; and
outputting the amended document.

12. The computer system of claim 11, further comprising:
adding a logo around the location.

13. The computer system of claim 12, further comprising:
receiving the outputted document;
detecting the logo in the outputted document;
accessing the code; and
identifying and retrieving the confidential content corresponding to the code.

14. The computer system of claim 13, further comprising:
matching the logo before retrieving the confidential content.

15. The computer system of claim 13, further comprising:
recreating the original document by merging the retrieved confidential content into the outputted document.

16. The computer system of claim 11, further comprising:
adding an IR security mark to the amended document.

17. The computer system of claim 11, wherein outputting the amended document comprises:
one or more of printing the amended document or displaying the amended document.

18. The computer system of claim 11, wherein the hardware processor comprises:
one or more of a mobile device or a multi-function device.

19. A computer program product for executing an augmented reality (AR) application, the AR application securing and accessing confidential content of an original document, the computer program product comprising a computer-readable storage medium having program instructions embodied therewith, the program instructions executable by a computing device to cause the computing device to perform operations comprising:
receiving the original document;
receiving an indication of the confidential content in the original document;
amending the original document by masking the confidential content in the original document, adding a code to the original document at a location of the masked confidential content, and adding a logo around the location; and
outputting the amended document.

20. The computer program product of claim 19, wherein the operations further comprise:
receiving the outputted document;
detecting the logo in the outputted document;
accessing the code; and
identifying and retrieving the confidential content corresponding to the code.
